(19) United States
(12) Patent Application Publication
(10) Pub. No.: US 2021/0009721 A1
(43) Pub. Date: Jan. 14, 2021

(54) PROCESS FOR PRE-CONTACTING METALLOCENE CATALYST COMPONENTS TO PRODUCE AMORPHOUS POLY ALPHA-OLEFINS

(71) Applicant: REXTAC LLC, Odessa, TX (US)

(72) Inventors: Andres Sustic, Odessa, TX (US); Mitchell Arnold, Odessa, TX (US); Nick Fowler, Odessa, TX (US)

(21) Appl. No.: 16/945,654

(22) Filed: Jul. 31, 2020

Related U.S. Application Data
(63) Continuation-in-part of application No. 16/508,491, filed on Jul. 11, 2019.

(51) Int. Cl. C08F 10/02

(52) U.S. Cl. CPC C08F 10/02

(57) ABSTRACT

A continuous process for pre-contacting coordination polymerization catalyst components with each other before they are introduced into a polymerization reactor at 130 degrees Fahrenheit to 200 degrees Fahrenheit, where the activated coordination catalyst is contacted with at least one monomer to produce amorphous poly alpha olefin (APAO). Embodiments of the process involves blending a metallocene pre-catalyst with an organic solvent forming a metallocene pre-catalyst solution and flowing a co-catalyst mixture into the metallocene pre-catalyst solution continuously in a pre-contacting device, forming an activated metallocene catalyst. Embodiments further involve continuously injecting the activated metallocene catalyst into the heated polymerization reactor while simultaneously and continuously injecting propylene monomer and/or other alpha-olefin monomers, and hydrogen gas for molecular weight control, initiating an exothermic reaction forming a monomer-polymer-catalyst slurry. Embodiments further involve continuously stirring the monomer-polymer-catalyst slurry forming an amorphous poly alpha olefin with a saturated backbone.

### CROSS REFERENCE TO RELATED APPLICATIONS

This application is a continuation-in-part of, and claims the filing date benefit of, co-pending U.S. patent application Ser. No. 16/508,491, filed Jul. 11, 2019.

### FIELD

The present disclosure generally relates to amorphous poly alpha-olefin (“APAO”) compositions. In particular, the present disclosure relates to continuous processes for producing an amorphous poly alpha olefin.

### BACKGROUND

APAO are presently used in a wide variety of applications including adhesives, such as packaging adhesives, indirect food contact packaging adhesives, product assembly adhesives, woodworking adhesives, flooring adhesives, automotive assembly adhesives, structural adhesives, mattress adhesives, pressure sensitive adhesives (“PSA”), PSA tapes, PSA labels, PSA protective films, self-adhesive films, laminating adhesives, flexible packaging adhesives, heat seal adhesives, industrial adhesives, hygiene nonwoven construction adhe-sives, hygiene core integrity adhesives, and hygiene elastic attachment adhesives. APAO are presently used in sealants and coatings. Additionally, these materials may be blended with other materials to achieve a wide range of desired physical properties.

Typically, using Ziegler-Matta catalyst technologies, amorphous poly alpha olefins are produced by the co-polymerization of α-olefins, for example, ethylene (CAS#74-85-1), propylene (CAS#115-07-1), 1-butene (CAS#106-98-9) or 1-hexene (CAS#592-41-6). Due to the specific nature of the polymerization process, the co-polymers and terpolymers may have an amorphous structure.

Examples of amorphous poly alpha olefins include, for example, amorphous (also known as atactic) polypropylene (“APP,” CAS#9003-07-0), amorphous propylene, polymer with ethylene (“APE,” CAS#9010-79-1), amorphous propylene, polymer with 1-butene (“APB,” CAS#29160-13-2), amorphous propylene, polymer with 1-hexene (“APH,” CAS#25895-44-7), amorphous 1-butene, polymer with 1-hexene (“ABH,” no CAS# found) copolymers, amorphous propylene, polymer with ethylene and 1-butene (“APEB,” CAS#25895-47-0), amorphous propylene, polymer with ethylene and 1-hexene (“APEH,” no CAS# found), amorphous propylene, polymer with 1-butene and 1-hexene (“APBH,” no CAS# found) terpolymers and finally amorphous propylene, polymer with ethylene, 1-butene and 1-hexene (“APEBH,” no CAS# found) tetrapolymers.

### BRIEF DESCRIPTION OF THE DRAWINGS

The detailed description will be better understood in conjunction with the accompanying drawings as follows:

FIG. 1 depicts a diagram of the equipment used in processes according to embodiments of the present disclosure.

FIG. 2 depicts a method for preparing APAO according to one embodiment of the present disclosure.

The present embodiments are detailed below with reference to the listed Figures.

### DETAILED DESCRIPTION

Before explaining the present process in detail, it is to be understood that the process is not limited to the particular embodiments and that it can be practiced or carried out in various ways.

Embodiments of the present disclosure relate to a continuous process for pre-contacting coordination polymerization catalyst components with each other before they are introduced into a polymerization reactor, where the activated coordination catalyst is contacted with at least one monomer to produce amorphous poly alpha olefin (“APAO”). According to one embodiment, a solid metallocene pre-catalyst is dissolved in an organic solvent forming a metallocene pre-catalyst solution. A co-catalyst solution is flowed into the flowing metallocene pre-catalyst solution continuously in a pre-contacting device, forming an activated metallocene catalyst. The activated metallocene catalyst is continuously injected into a polymerization reactor heated to 130 degrees Fahrenheit to 200 degrees Fahrenheit, while simultaneously and continuously injecting into the polymerization reactor propylene monomer, and optionally ethylene monomer, 1-butene monomer, 1-hexene monomer, and hydrogen gas for melt viscosity control, initiating an exothermic reaction forming a monomer-polymer-catalyst slurry, then continuously stirring the monomer-polymer-catalyst slurry forming an amorphous poly alpha olefin with a saturated backbone.

Preferred coordination polymerization pre-catalysts of the metallocene type, based on Group IV transition metals, can be Diphenylmethylidene (cyclopentadienyl) (9-fluorenyl) zirconium dichloride, or Ethylidene dicyclopentadiene zirconium dichloride. A preferred co-catalyst is methylaluminoxane [(MeAlO)ₙ] (“MAO”). Unlike traditional and still widely used heterogeneous Ziegler-Natta catalysts, metallocenes are homogeneous catalysts.

The following definitions are used herein:

The term “neat co-catalyst” refers to the co-catalyst in pure, unadulterated form, with nothing added.

The term “diluted co-catalyst” refers to the neat co-catalyst that has been diluted with an organic solvent.

The term “metallocene pre-catalyst” refers to a metallocene species which has not been yet activated by reaction with a co-catalyst

According to one embodiment, the process involves maintaining a polymerization reactor at a temperature from 130 degrees Fahrenheit to 200 degrees Fahrenheit to form the desired amorphous poly alpha olefins (“APAO”).

In various embodiments, amorphous propylene-based homopolymers, copolymers, terpolymers or tetrapolymers with ethylene or 1-butene or 1-hexene, can be produced in a continuously stirred tank reactor (“CSTR”) at an extended temperature range of 130 degrees Fahrenheit to 200 degrees Fahrenheit using a metallocene or a single site pre-catalyst activated with a co-catalyst. This polymerization process in which the liquefied propylene monomer serves not only as the reaction medium to remove the high heat of polymerization reaction, but also serves as the monomer in the reaction, is also known as liquid pool or bulk polymerization reaction.

More specifically, external to the polymerization reactor, a solid metallocene pre-catalyst may be blended with a liquid organic solvent at a pre-catalyst: liquid organic solvent ratio of from 1 lb:5 lb to 1 lb:500 lb to form a metallocene pre-catalyst solution.

A co-catalyst mixture may be flowed continuously into a pre-contacting device while simultaneously flowing the metallocene pre-catalyst solution into the pre-contacting device forming an activated metallocene catalyst with a co-catalyst to metallocene pre-catalyst solution molar ratio of from 2:1 to 7500:1 of Group 13:Group 4 elements of the periodic table.

The co-catalyst mixture is formed from a co-catalyst, wherein the co-catalyst is at least one of a neat co-catalyst and a diluted co-catalyst, the co-catalyst being an alkylated metal from Group 13 of the periodic table.

The activated metallocene catalyst is continuously injected into the heated polymerization reactor while simultaneously injecting propylene monomer and optionally ethylene monomer, or 1-butene monomer or 1-hexene monomer into the heated polymerization reactor initiating an exothermic reaction forming a monomer-polymer-catalyst slurry.

The monomer-polymer-catalyst slurry is continuously stirred in the polymerization reactor under a pressure from 120 psi to 550 psi using a residence time from 30 minutes to 5 hours, thereby forming an amorphous poly alpha olefin, wherein the amorphous poly alpha olefin has a saturated backbone.

The molecular weight of the formed homopolymers, copolymers, terpolymers, and/or tetrapolymers of propylene, according to various embodiments of the present disclosure, may be controlled by the addition of an appropriate amount of a chain terminating agent, for example from about 0.5 mole % to about 5.0 mol % hydrogen gas, based on the monomer feed rate used in the process.

In some instances, a liquid organic chemical with specific performance properties is added concurrently with the pre-catalyst and the co-catalyst in order to have the polymerization process in the CSTR run more smoothly.

In embodiments, the co-catalyst is a methylaluminoxane. In other embodiments, the co-catalyst can be an organic borate.

In embodiments, hydrogen is added as a chain transfer agent to control the molecular weight of APAO, for example from about 0.5 to about 5.0 mol % hydrogen, based on the monomer feed to the process.

In some embodiments, the heating of the polymerization reactor is by steam heating. In other embodiments, the polymerization reactor is heated using other methods as may be appropriate.

In embodiments, the process introduces a second alpha olefin monomer into the polymerization reactor, wherein the second alpha olefin monomer is at least one of: ethylene, 1-butene, or 1-hexene, forming a copolymer.

In embodiments, a third alpha olefin monomer is introduced with the first and second alpha olefin monomers into the polymerization reactor, wherein the third alpha olefin monomer is selected from the group of: ethylene, 1-butene, or 1-hexene, forming a terpolymer.

In embodiments, a fourth alpha olefin monomer is introduced into the polymerization reactor with the first, second, and third alpha olefin monomers, wherein the fourth alpha olefin monomer is selected from the group: ethylene, 1-butene, and 1-hexene, forming a tetrapolymer.

In embodiments, the temperature of the polymerization reactor is maintained using a heating jacket surrounding the polymerization reactor or insulation enclosing the polymerization reactor.

In embodiments, the metallocene pre-catalyst solution flows at a flow rate from 0.2 lb/hr to 20 lb/hr.

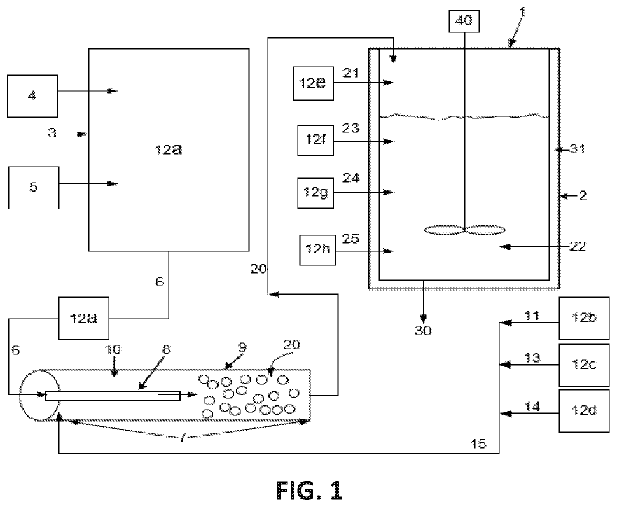

Turning now to the figures, FIG. 1 shows a continuous process for pre-contacting coordination polymerization catalyst components to produce amorphous poly alpha olefin (“APAO”) according to one embodiment of the present disclosure.

The equipment includes a closed polymerization reactor 1 with a heating jacket 2 surrounding the polymerization reactor for startup of the reaction by injecting steam or other fluid into the reactor heating jacket 2.

The equipment includes a pre-catalyst solution container 3.

A solid metallocene pre-catalyst 4 is dispensed into the pre-catalyst solution container 3. An organic solvent 5 is injected into the pre-catalyst solution container 3 forming the metallocene pre-catalyst solution 6.

The solid metallocene pre-catalyst mixes with the organic solvent in a pre-catalyst:organic solvent ratio from 1 lb:5 lb to 1 lb:500 lb forming a metallocene pre-catalyst solution 6.

The equipment includes a pre-contacting device 7. Embodiments of the pre-contacting device 7 has an inner tube 8, an outer tube 9 and an annulus 10.

Eight pumps are used: pumps 12a, 12b, 12c, 12d, 12e, 12f, 12g, and 12h in this embodiment. If additional monomers or ingredients need to be used, then additional pumps can be added.

Pump 12a flows a metallocene pre-catalyst solution 6 into an inner tube 8 of pre-contacting device 7.

Pump 12b flows a co-catalyst 11 into a conduit 15. The co-catalyst is at least one of a neat co-catalyst, a diluted co-catalyst, or a mixture of a neat and a diluted co-catalyst. The co-catalyst consists of methylaluminoxane from the Group 13 of the periodic table.

Pump 12c flows an optional component, such as a liquid alkyl aluminum 13 with specific performance properties into the conduit 15.

Pump 12d flows an optional component, such as a liquid organic chemical 14 with specific performance properties into the conduit 15.

The pre-contacting device 7 provides a residence time sufficient to activate the metallocene pre-catalyst in the metallocene pre-catalyst solution 6 by 50% to 100%, forming an activated metallocene catalyst 20.

The molar ratio of methylaluminoxane co-catalyst to the metallocene catalyst component containing Zirconium or Hafnium, i.e., the Al/Zr ratio, ranges between 2:1 and 7500:1 according to various embodiments. In one embodiment, the ratio is preferably between 20:1 and 500:1.

Continuously, the activated metallocene catalyst 20 is injected into the preheated polymerization reactor 1 while simultaneously at least a propylene monomer 21 is pumped into the polymerization reactor using a pump 12e into the preheated polymerization reactor 1 initiating an exothermic reaction forming a monomer-polymer-catalyst slurry 22.

In some embodiments, more than one monomer can be added simultaneously with the process to produce a copolymer of the amorphous poly alpha olefin 31.

The formed monomer-polymer-catalyst slurry 22 may be constantly mixed as components are continuously injected in the heat controlled polymerization reactor 1 under a pressure from 120 psi to 550 psi using a residence time from 30 minutes to 5 hours forming an amorphous poly alpha olefin 30, which may be continuously harvested from the polymerization reactor 1 wherein the amorphous poly alpha olefin has a saturated backbone.

FIG. 1 also shows that a second alpha olefin monomer, the optional ethylene monomer 23, can be introduced into the polymerization reactor 1 with pump 12f.

In some embodiments, the third alpha olefin monomer 24 can be: hexene-1 liquid, or butene-1 liquid, instead of optional ethylene monomer 23 forming a copolymer.

FIG. 1 depicts that a third alpha olefin monomer 24 can be introduced into the polymerization reactor 1 with pump 12g, wherein the third alpha olefin monomer is selected from the group of: 1-hexene liquid, 1-butene liquid, or ethylene gas to form a terpolymer within polymerization reactor 1.

FIG. 1 depicts that a fourth alpha olefin monomer 25 can be introduced into the polymerization reactor 1 with pump 12h, wherein the fourth alpha olefin monomer is selected from the group of: hexene-1 liquid, butene-1 liquid, and ethylene gas to form a tetrapolymer within polymerization reactor 1.

When two monomers are used, the formed APAO can be a copolymer. When three monomers are used, the formed APAO can be a terpolymer. When 4 monomers are used, the formed APAO can be a tetrapolymer.

FIG. 1 shows that the mixing can be done using electric motor 40 in the polymerization reactor 1, driving stirring paddles.

FIG. 1 also depicts air space 31 between an exemplary heating jacket 2 and the polymerization reactor 1 when other types of heating are used to increase temperature of the contents of the reactor.

According to one embodiment of the present disclosure, following the mixing operation, the next step involves flowing a co-catalyst mixture of methylaluminoxane into a pre-contacting device 7 having a first tube 8 within a second tube 9, the second tube being radially positioned approximately 4 inches from the center of the first tube.

In one embodiment, the first tube 8 has a diameter 66% of the diameter of the second tube 9. In various embodiments, the second tube varies in diameter from 25% to 80% of the diameter of the first tube 8.

According to embodiments of the present disclosure, the co-catalyst is flowed into the pre-contacting device while simultaneously flowing the metallocene pre-catalyst solution into the pre-contacting device 7 forming an activated metallocene catalyst.

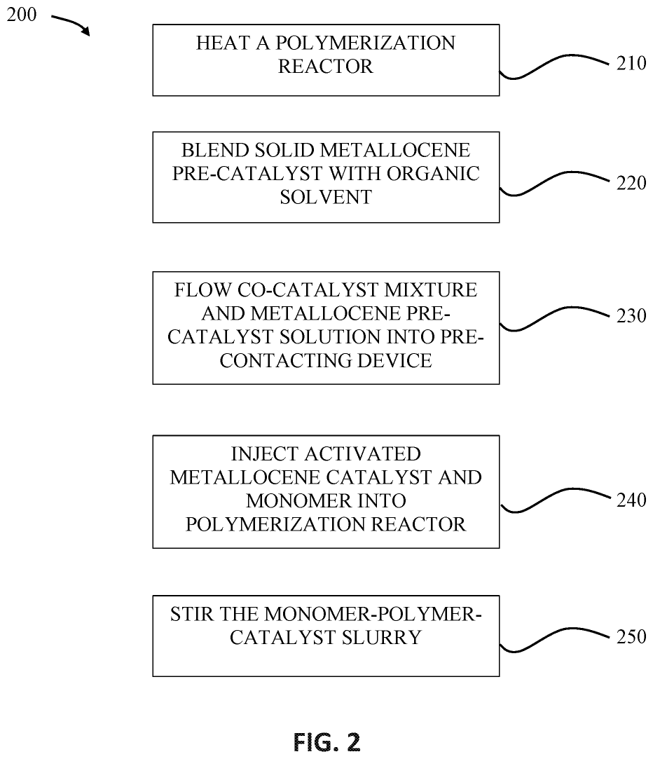

FIG. 2 depicts a method 200 of producing amorphous poly alpha olefin (“APAO”) carried out according to one embodiment process of the present disclosure.

According to one embodiment, the method of producing APAO 200 comprises a continuous process for pre-contacting coordination polymerization catalyst components. According to one embodiment, method of producing APAO 200 includes PREHEAT POLYMERIZATION REACTOR 210. According to various embodiments, HEAT POLYMERIZATION REACTOR 210 comprises heating the polymerization reactor to a temperature from 130 degrees Fahrenheit to 200 degrees Fahrenheit using a heating jacket surrounding the polymerization reactor. According to some embodiments, HEAT POLYMERIZATION REACTOR 210 comprises heating the polymerization reactor by other means as may be appropriate. Various embodiments of HEAT POLYMERIZATION REACTOR 210 comprise preheating the polymerization reactor to a temperature from 130 degrees Fahrenheit to 200 degrees Fahrenheit. Some embodiments of HEAT POLYMERIZATION REACTOR 210 comprise maintaining the polymerization reactor at a temperature from 130 degrees Fahrenheit to 200 degrees Fahrenheit.

Embodiments of method of producing APAO 200 further comprise BLEND SOLID METALLOCENE PRE-CATALYST WITH ORGANIC SOLVENT 220. In embodiments of BLEND SOLID METALLOCENE PRE-CATALYST WITH ORGANIC SOLVENT 220, a metallocene pre-catalyst is blended with an organic solvent in a pre-catalyst container, forming a metallocene pre-catalyst solution. In one embodiment of BLEND SOLID METALLOCENE PRE-CATALYST WITH ORGANIC SOLVENT 220, the pre-catalyst is mixed with the organic solvent in a ratio of 1 lb:5 lb to 1 lb:50 lb. In another embodiment of BLEND SOLID METALLOCENE PRE-CATALYST WITH ORGANIC SOLVENT 220, blending of the metallocene pre-catalyst to organic solvent is in a ratio of 1 lb:5 lb to 1 lb:500 lb, thereby forming a metallocene pre-catalyst solution.

One embodiment of BLEND SOLID METALLOCENE PRE-CATALYST WITH ORGANIC SOLVENT 220 involves blending, external to the polymerization reactor, the metallocene pre-catalyst with an organic solvent.

Embodiments of method of producing APAO 200 further comprise FLOW CO-CATALYST MIXTURE AND METALLOCENE PRE-CATALYST SOLUTION INTO PRE-CONTACTING DEVICE 230. Embodiments of FLOW CO-CATALYST MIXTURE AND METALLOCENE PRE-CATALYST SOLUTION INTO PRE-CONTACTING DEVICE 230 involve flowing a co-catalyst mixture into a pre-contacting device while simultaneously flowing the metallocene pre-catalyst solution produced during BLEND SOLID METALLOCENE PRE-CATALYST WITH ORGANIC SOLVENT 220 into the pre-contacting device and maintaining a total flowrate of the co-catalyst mixture and the metallocene pre-catalyst solution from 0.2 lb/hr to 20 lb/hr using a residence time sufficient to activate the metallocene pre-catalyst by 50%-100%, thereby forming an activated metallocene catalyst.

Various embodiments of FLOW CO-CATALYST MIXTURE AND METALLOCENE PRE-CATALYST SOLUTION INTO PRE-CONTACTING DEVICE 230 involve flowing a co-catalyst mixture into a pre-contacting device while simultaneously flowing the metallocene pre-catalyst solution into the pre-contacting device and forming an activated metallocene catalyst with a co-catalyst to metallocene pre-catalyst solution molar ratio of from 2:1 to 7500:1 of Group 13:Group 4 elements of the periodic table.

Embodiments of method of producing APAO 200 further comprise INJECT ACTIVATED METALLOCENE CATALYST AND MONOMER INTO POLYMERIZATION REACTOR 240. Embodiments of INJECT ACTIVATED METALLOCENE CATALYST AND MONOMER INTO POLYMERIZATION REACTOR 240 involve continuously injecting the activated metallocene catalyst produced during FLOW CO-CATALYST MIXTURE AND METALLOCENE PRE-CATALYST SOLUTION INTO PRE-CONTACTING DEVICE 230 into the preheated polymerization reactor while simultaneously injecting propylene monomer into the heated polymerization reactor, thereby initiating an exothermic reaction forming a monomer-polymer-catalyst slurry. In one embodiment of INJECT ACTIVATED METALLOCENE CATALYST AND MONOMER INTO POLYMERIZATION REACTOR 240, ethylene, 1-butene, or 1-hexene is simultaneously injected into the preheated polymerization reactor. In some embodiments of INJECT ACTIVATED METALLOCENE CATALYST AND MONOMER INTO POLYMERIZATION REACTOR 240, more than one monomer can be added simultaneously with the process to produce a copolymer of the amorphous poly alpha olefin. According to embodiments of INJECT ACTIVATED METALLOCENE CATALYST AND MONOMER INTO POLYMERIZATION REACTOR 240, various combinations of monomers selected from the group consisting of propylene, ethylene, 1-butene, or 1-hexene are injected into the preheated polymerization reactor.

Embodiments of method of producing APAO 200 further comprise STIR THE MONOMER-POLYMER-CATALYST SLURRY 250. Embodiments of STIR THE MONOMER-POLYMER-CATALYST SLURRY 250 involve continuously stirring the monomer-polymer-catalyst slurry in the polymerization reactor under a pressure from 120 psi to 550 psi using a residence time from 30 minutes to 5 hours forming an amorphous poly alpha olefin having a saturated backbone.

In embodiments of STIR THE MONOMER-POLYMER-CATALYST SLURRY 250, an organic solvent is used to dissolve the metallocene pre-catalyst. In some embodiments of STIR THE MONOMER-POLYMER-CATALYST SLURRY 250, the organic solvent can be toluene, hexane, heptane, or mineral spirits at any ratio of solvent to pre-catalyst between 5:1 and 500:1. In this embodiment, the co-catalyst can be methylaluminoxane. In this embodiment, an external heater can be used to provide steam heat to the jacket of the polymerization reactor.

While these embodiments have been described with emphasis on the embodiments disclosed, it should be understood that within the scope of the appended claims, the embodiments might be practiced other than as specifically described herein.

What is claimed is:

1. A continuous process for pre-contacting coordination polymerization catalyst components with each other and at least one monomer to produce amorphous poly alpha olefin (“APAO”), the continuous process comprising:
a. maintaining a polymerization reactor at a temperature from 130 degrees Fahrenheit to 200 degrees Fahrenheit;
b. external to the polymerization reactor, blending a metallocene pre-catalyst with an organic solvent, the pre-catalyst to organic solvent ratio being 1 lb:5 lb to 1 lb:500 lb, thereby forming a metallocene pre-catalyst solution;
c. flowing a co-catalyst mixture into a pre-contacting device while simultaneously flowing the metallocene pre-catalyst solution into the pre-contacting device and forming an activated metallocene catalyst with a co-catalyst to metallocene pre-catalyst solution molar ratio of from 2:1 to 7500:1 of an element from Group 13:an element of Group 4 of the periodic table, the co-catalyst mixture comprising:
(i) a co-catalyst, wherein the co-catalyst is at least one of a neat co-catalyst and a diluted co-catalyst, the co-catalyst being an alkylated metal from Group 13 of the periodic table;
d. continuously injecting the activated metallocene catalyst into the heated polymerization reactor while simultaneously injecting propylene monomer and hydrogen gas for melt viscosity control, into the heated polymerization reactor initiating an exothermic reaction forming a monomer-polymer-catalyst slurry; and
e. continuously stirring the monomer-polymer-catalyst slurry in the polymerization reactor under a pressure from 120 psi to 550 psi using a residence time from 30 minutes to 5 hours forming an amorphous poly alpha olefin, wherein the amorphous poly alpha olefin has a saturated backbone.

2. The continuous process of claim 1, the organic solvent comprising toluene, hexane, heptane, or mineral spirits.

3. The continuous process of claim 1, further comprising using steam heat to heat the polymerization reactor.

4. The continuous process of claim 1, wherein continuously injecting the activated metallocene catalyst into the heated polymerization reactor while simultaneously injecting propylene monomer and hydrogen gas further comprises injecting an ethylene monomer into the heated polymerization reactor.

5. The continuous process of claim 1, wherein continuously injecting the activated metallocene catalyst into the heated polymerization reactor while simultaneously injecting propylene monomer and hydrogen gas further comprises injecting an alpha-olefin monomer into the heated polymerization reactor.

6. The continuous process of claim 5, further comprising injecting a second alpha olefin monomer into the heated polymerization reactor, forming a copolymer.

7. The continuous process of claim 6, wherein the second alpha olefin monomer is selected from the group consisting of ethylene, 1-butene, and 1-hexene.

8. The continuous process of claim 6, further comprising injecting a third alpha olefin monomer into the heated polymerization reactor, wherein the third alpha olefin monomer is selected from the group consisting of ethylene, 1-butene and 1-hexene, forming a terpolymer.

9. The continuous process of claim 8, further comprising injecting a fourth alpha olefin monomer into the heated polymerization reactor, wherein the fourth alpha olefin monomer is selected from the group consisting of ethylene, 1-butene and 1-hexene, forming a tetrapolymer.

10. The continuous process of claim 1, wherein flowing the metallocene pre-catalyst solution into the pre-contacting device, comprises flowing the metallocene pre-catalyst solution at a flow rate from 0.2 lb/hr to 20 lb/hr.
